(19) United States
(12) Patent Application Publication
(10) Pub. No.: US 2007/0265954 A1
(43) Pub. Date: Nov. 15, 2007

(54) GRAPHICAL USER INTERFACE TRADING WIDGET FOR TRADING FINANCIAL INSTRUMENTS

(76) Inventors: Timothy S. Mather, Englewood, CO (US); Michael J. Glista, Homer Glen, IL (US); Ernst Popke, Highlands Ranch, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 11/684,558

(22) Filed: Mar. 9, 2007

Related U.S. Application Data
(60) Provisional application No. 60/781,211, filed on Mar. 10, 2006.

(51) Int. Cl. G06Q 40/00

(52) U.S. Cl. 705/37

(57) ABSTRACT

Methods, systems mediums and graphical user interfaces are provided for monitoring and trading of financial instruments. According to various embodiments, a graphical user interface (GUI) trading widget for electronic trading of financial instruments is provided which floats translucently over the surface of a price chart dynamically displaying market action. The trading widget enables a trader to specify parameters of an order (e.g., buy, sell, quantity, price, limits, etc.), and enter the order into an electronic exchange. The trading widget can positioned on the chart where the trading widget is most convenient for trade execution and least intrusive on the display of price or other market information.

### CROSS-REFERENCE TO RELATED APPLICATIONS

This application claims the benefit of Provisional Application No. 60/781,211, filed on Mar. 10, 2006, which is hereby incorporated by reference in its entirety.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2006-2007, CQGT Inc.

### TECHNICAL FIELD

Various embodiments of the present invention generally relate to systems and methods for trading financial instruments. More specifically, embodiments of the present invention relate a graphical user interface trading widget for trading financial instruments.

### BACKGROUND

In the field of financial trading, trading of financial instruments (e.g., securities, commodity, currency, or index futures, options, etc.) is typically done today through an electronic exchange, rather than on the historical “trade floor”. Trading through an electronic exchange enables virtually anyone with a computer to trade directly with the exchange. Via a trader's computer that accesses the exchange via a network, the trader can obtain real-time or historical financial data, place orders (e.g., market, stop, limit, or stop limit orders) to buy or sell a financial instrument, perform a wide range of financial analyses, and much more. In addition, data can be presented to the trader in various useful formats, such as graphical or alphanumeric. The manner of presentation of data and the interface through which the trader enters orders to the market are typically very important to traders because they can effect timeliness of data presentation, the timeliness of order entry, the ability of the trader to observe and capitalize on market trends, and so on.

Traditional order interfaces are generally presented separately from price charts. For example, the order interface may be in a different window or screen than the price chart. Thus, when a trader desires to make a trade, the trader must navigate to the order placement interface resulting in loss of focus on the streaming financial data being presented in the price chart. In addition, traders often desire to monitor multiple financial instruments simultaneously. The traditional order placement interfaces require that the trader use great care to ensure that a trade will occur with the desired financial instrument.

As such, there are a number of challenges and inefficiencies created in the placement of financial order through traditional trading applications. The trader is not able to quickly and easily review, modify, and place financial product orders when the trader's attention is focused on the price chart. It is with respect to these and other problems that embodiments of the present invention have been made.

### SUMMARY

Systems, methods, mediums and graphical user interfaces are described for monitoring and trading financial instruments. According to one embodiment, a movable graphical user interface (GUI) (hereafter, “trading widget”) for electronic trading of financial instruments is provided. The trading widget generally enables a trader to quickly and efficiently specify parameters of an order (e.g., buy, sell, quantity, price, limits, etc.), and enter the order into an electronic exchange. The trading widget can be moved by the trader, and positioned on the chart where the trading widget is most convenient for trade execution and least intrusive on the display of price or other market information.

According to one embodiment, the trading widget may take on a plurality of states or modes. For example, the trading widget may have an inactive mode or an active mode. From the inactive mode, the trading widget may be activated when the input device pointer (e.g., mouse pointer) is moved over (e.g., hovers over) or is within some set proximity of the trading widget. According to various embodiments, in the inactive mode, regions of the trading widget may be deemphasized, highlighted, muted, enabled/disabled, marked, and/or turned to a translucent state, While in the active mode, regions may be highlighted using color, a bold font, or some other marking to indicate which component of the trading widget might be used to initiate an action. According to one embodiment, the trading widget may have a active market mode which causes the trading widget to display an order quantity, best bid, and best ask price in a central region that is used by the trader to submit market orders. Other active modes for submitting other order types are described below.

In accordance with various embodiments, the trading widget includes a central region that displays an order quantity and an order price or order prices. The central region may also contain a portion referred to as a “handle” for grabbing and moving the trading widget.

According to one embodiment, if the trader clicks on the display of the quantity the numerals of the quantity may be displayed using a bold font and the mode of the trading widget may change so that the response to the trader moving the mouse wheel may be adjusting the order quantity. If the trader clicks on the bolded quantity, the scroll action response may be restored to the default state.

In one or more embodiments of the present invention, the trading widget is an integrated component of a trading application. The trading application may include one or more price charts which are dynamically updated based on financial instrument data received from a financial exchange or other information source. In one embodiment, the trading widget and associated price chart are coupled. For example, placing an order using the trading widget will result in a line being drawn on the price chart. Similarly, according to one embodiment, a line on the price chart can be moved by the user causing a change in the order parameters or even an order that has been submitted to the financial exchange.

In some embodiments, a method for placing, monitoring, and/or updating trading orders may include receiving data related to a financial instrument from an electronic exchange. The data may be received directly from an exchange server or from a financial data server hosting a server side application. The data is then dynamically presented as it is received from the electronic exchange in a price chart. According to various embodiments, the price chart includes a trading widget displayed which may be initialized in an inactive mode. The system then monitors for cursor movements of a trader to determine if the cursor has been positioned over the trading widget. Once the cursor is positioned over the trading widget, the trading widget's operating mode changes from an inactive mode to an active mode.

In some embodiments, the method also includes receiving an order command from the trading widget and submitting the order to the electronic exchange.

Some embodiments of the present invention relate to computer-implemented methods comprising displaying a first user interface screen, displaying a graphical trading widget, and dynamically updating the state of the trading widget based on interactions with a user. In one embodiment, a first user interface screen is displayed on a terminal. The first user interface screen may include a price chart to display information received from an exchange about a financial instrument. A graphical trading widget is also displayed on the terminal according to one or more embodiments. In some embodiments, the graphical trading widget may appear in a translucent state when in an inactive mode and in an opaque state when in an active mode. Additional button may appear/disappear or be enabled/disabled depending on the operational mode. In some embodiments, the trading widget changes color depending on the current operational mode.

According to one embodiment, the graphical trading widget enters the active mode when a cursor is positioned over the graphical trading widget. In some operational modes, the price field, volume field, best bid/ask price, and/or depth of market field within the trading widget may also be dynamically updated in response to data received from an electronic exchange.

In some embodiments, the trading widget and the price chart are interactive. For example, a horizontal line on the price chart may be displayed indicating a limit or stop order that has been placed. A trader may interact with the line resulting in the order being cancelled or modified.

Some embodiments of the present invention relate to a financial trading system comprising a financial exchange interface module, a price chart rendering module, a trading widget module, and an order placement module. The financial exchange interface module, according to various embodiments, is configured to receive financial instrument data from a financial exchange, financial data server, server side applications, and/or other source. According to one embodiment, the price chart rendering module is communicably coupled to the financial exchange interface module and is configured to graphically display the financial instrument data received from the financial exchange on a display device. The trading widget module may be configured to graphically present a trading widget on the display device and receive financial orders from the trading widget. When an order is received through the trading widget, the order placement module submits the received financial orders to the financial exchange.

The financial trading system of some embodiments may also include a data processing module. The data processing module may be configured to receive financial data from the financial exchange and process the financial data before transmitting the financial data to the price chart rendering module.

According to various embodiments, a computer-readable storage medium containing a set of instructions capable of causing one or more processors to generate a trading widget with a plurality of states may be provided. The plurality of states may include, but are not limited to, an inactive mode, and one or more active modes. In one embodiment, the inactive mode causes the trading widget to be displayed in a translucent state. In some embodiments, the active mode results from the detection of a cursor positioned over the trading widget causes the trading widget to be displayed in an opaque state and allows a user to submit orders to an electronic exchange. For example, the market mode of one embodiment causes the trading widget to display in a central region one or more of an order quantity, a best bid price, and a best ask price of a financial instrument and to the side of the central region two order action buttons usable to execute market orders.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating an exemplary operating environment in which one or more embodiments of the present invention may be used;

FIG. 2 is a block diagram of various components in an exemplary trading application that uses a trading widget in accordance with various embodiments of the present invention;

FIG. 3 illustrates an exemplary price chart including a small graphical user interface (GUI) trading widget for electronic trading of financial instruments in accordance with embodiments of the present invention;

FIGS. 4-5 illustrate additional views of an exemplary price chart with a trading widget in accordance with an embodiment of the present invention;

FIG. 6 illustrates a portion of an exemplary price chart with lines indicating limit orders in accordance with various embodiments of the present invention;

FIG. 7 is a flowchart illustrating an exemplary algorithm for placing an order in accordance with one embodiment of the present invention;

FIG. 8 is a flowchart illustrating an exemplary algorithm for modifying or canceling an order in accordance with an embodiment of the present invention;

FIGS. 9a-9g show various embodiments of a trading widget; and

FIG. 10 illustrates an exemplary computer system with which embodiments of the present invention may be used.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Methods, systems and graphical user interfaces are described for monitoring and trading financial instruments. According to one embodiment, a small trading widget for electronic trading of financial instruments is provided. More specifically, the trading widget enables a trader to specify parameters of an order (e.g., buy, sell, quantity, price, limits, etc.), and enter the order into an electronic exchange. The trading widget can be moved by the trader, and positioned on the chart where the trading widget is most convenient for trade execution and least intrusive on the display of price or other market information.

Some embodiments of the present invention relate to the trading of financial instruments while monitoring market action dynamically displayed on a price chart. In particular, these embodiments relate to graphical user interfaces that facilitate placement of trade orders by traders of financial instruments, while displaying market data, such as short-term historical market price and trade volume information as well as other related analyses. According to one embodiment, the trading widget floats translucently over the surface of a chart allowing a trader to see the part of the price chart behind the trading widget. The trading widget may automatically become opaque in some embodiments when in use by the trader. Still yet, in various embodiments, the state of the trading widget may be indicated in other ways. As one example, color changes or highlighting of the background, text, or buttons may indicate when the trading widget is in use by the trader.

Embodiments described herein use a computer mouse as an input device; however, those skilled in the art will appreciate that other input devices may be used, such as, but not limited to, a track ball, a keyboard, audio input (e.g., with speech recognition), and touch screen input (e.g., with a stylus). There are also numerous different types of computer mice: two button, three button, having a mouse wheel or roller ball, etc. The invention is not limited to any particular type of input device, or any particular type of mouse.

According to one embodiment, the trading widget may take on a plurality of states or modes. For example, the trading widget may have an inactive mode or an active mode. From the inactive mode, the trading widget may be activated when the input device pointer (e.g., mouse pointer) is moved over (e.g., hovers over) the trading widget. In the inactive mode, regions of the trading widget may be muted and/or translucent, while in the active mode, regions may change to bold and highlighted. Still yet, various features (e.g., trading buttons, trend arrows, handle, etc.) of the trading widget may appear or disappear depending on the state of the trading widget. Consequently, embodiments of the present invention envision that any number of different types and forms of visual attributes can be chosen to appear, disappear or change depending upon the particular mode of the trading widget.

In accordance with various embodiments, the trading widget includes a central region that displays an order quantity and an order price or order prices. The central region may also contain a portion referred to as a “handle” for grabbing and moving the trading widget. According to one embodiment, the default action in response to the trader moving the mouse wheel may be adjusting the order price. If the trader clicks on the display of the quantity the numerals of the quantity may be displayed using a bold font and the mode of the trading widget may change so that the response to the trader moving the mouse wheel may be adjusting the order quantity. If the trader clicks on the bolded quantity, the scroll action response may be restored to the default state.

While, for convenience, embodiments of the present invention are described with reference to trading financial instruments, embodiments of the present invention are equally applicable to various other information and decision-making situations.

For the sake of illustration, various embodiments of the present invention have herein been described in the context of computer programs, physical components, and logical interactions within modern computer networks. Importantly, while these embodiments describe various aspects of the invention in relation to modern computer networks, programs, and modules, the method and apparatus described herein are equally applicable to other systems, devices, and networks as one skilled in the art will appreciate. As such, the illustrated applications of the embodiments of the present invention are not meant to be limiting, but instead exemplary. In addition, embodiments are applicable to all levels of computing from the personal computer to large network mainframes and servers.

Terminology

Brief definitions of terms used throughout this application are given below.

The terms “connected” or “coupled” and related terms are used in an operational sense and are not necessarily limited to a direct connection or coupling. Thus, for example, two devices or modules may be connected or coupled directly, or via one or more intermediary media, modules, or devices. As another example, devices or modules may be connected or coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The term “financial instrument” generally refers to anything that can be traded with quantities and/or prices. Examples of financial instruments include, but are not limited to, stocks, bonds, mutual funds, Exchange-Traded Funds (EFTs), stock futures, commodity futures, stock options, commodity options and the like.

The phrase “grab the horizontal order line and drag it” generally refers to the action selecting the line, and moving the line while the line is still selected. In some embodiments, grabbing and dragging the horizontal line refers to the action of placing the mouse cursor over the line, the handle attached to the line, or the price cell attached to the line, pressing the left mouse button down and, while the mouse button remains down, moving the mouse cursor to a new location.

In an alternative embodiment, the phrase “grab the horizontal order line and drag it” may be taken to refer to the action of selecting the line by placing the mouse cursor over the line, the handle attached to the line, or the price cell attached to the line and clicking and then moving the line up or down or left or right using the arrow keys on a keyboard.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The phrase “line is dropped” generally refers to the action that terminates a drag of the horizontal order line by deselecting the line. In some embodiments, deselecting occurs by releasing the mouse button.

In an alternative embodiment, the phrase “line is dropped” may be taken to refer to the action that terminates the repositioning of the horizontal order line using the arrow keys on a keyboard by pressing the spacebar or alternatively, the “Enter” key.

If the specification states a component or feature “may”, “can”, “could”, or “might” be included or have a characteristic, that particular component or feature is not required to be included or have the characteristic.

The phrase “modify the order type from a stop order to a stop/limit order” generally refers to the action of adding a limit price that is different from the stop price and submitting a stop/limit order into the market. If the original order type was a stop/limit order with a stop price equal to a limit price at a financial exchange that does not support a stop order type, then a change in order type is not required.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “price chart” for a particular financial instrument generally refers to a graphical display where the vertical axis represents price and the horizontal axis represents time. In an alternative embodiment, the horizontal axis may represent price and the vertical axis may represent time. Order and/or trading activity for a discrete time interval may be drawn on the graph as points, connected points resulting in a line, or a bar representing a price range.

The term “responsive” includes completely or partially responsive.

The term “spanning horizontal line” on a price chart generally refers to a horizontal line the spans the entire chart graph display region.

The term “trader” generally refers to anyone using an input device, computerized or otherwise, to place trade orders, either to, e.g., buy or to sell a specific quantity of a financial instrument, into a market place.

The term “electronic exchange” generally refers to an entity that receives electronic orders from a trader and ensures fair matching between buyers and sellers. According to various embodiments, an electronic exchange includes not only exchanges which operate completely electronically, but also includes exchanges where one or more steps in the process of placing an order may occur manually. In accordance with various embodiments, the term may refer to a financial exchange such as a stock or a futures exchange or it may refer to a intermediary such as a brokerage firm or broker/dealer.

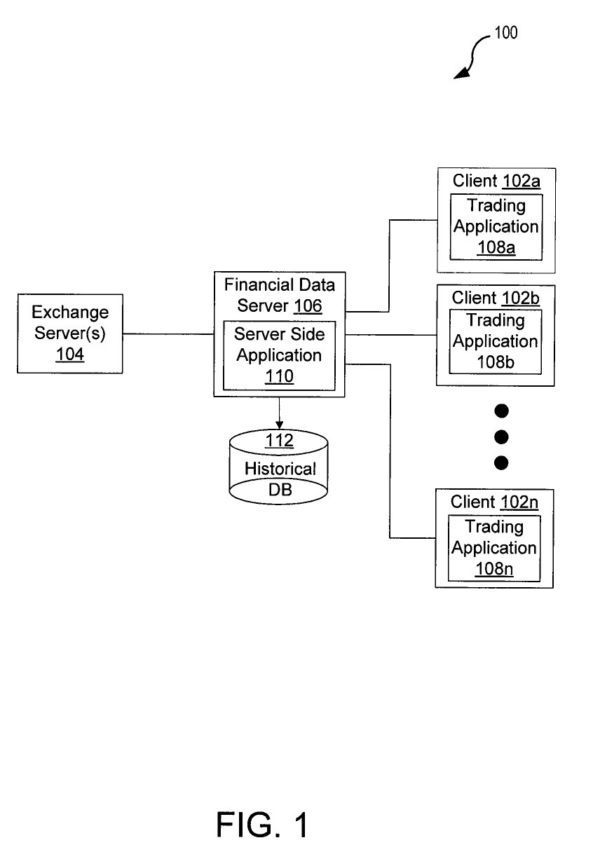

FIG. 1 illustrates an exemplary operating environment 100 in which embodiments of the present invention may be employed. One or more traders use client computers or terminals 102a-n to analyze data and place trade orders at electronic exchange server(s) 104. The electronic exchange server(s) 104 are servers associated with the electronic exchange that accept trade orders, provide requested data, provide a substantially real-time stream of bid, ask, and trade prices and volumes, and other data manipulation related to the electronic exchange. The clients 102a-n communicate with a financial data server 106 that facilitates communication of financial data and placement of trade orders.

Trading applications 108a-n operate on clients 102a-n, respectively. Trading applications 108a-n each gather financial data, process the data, present selected data to the trader on a display (not shown), receive input from the trader, and transmit trade orders to the server 106. More specifically, the trading applications 108a-n communicate with a server side application 110. The server side application 110 is operable to obtain selected data from the exchange server(s) 104 and communicate data to the exchange server(s) 104. Data communicated to the exchange server(s) 104 may be, for example, elements of trade orders, such as buy or sell, quantity, stop or limit prices, or others.

In the embodiment shown, financial data server 106 utilizes a database 112 for storing data, such as historical price and volume data and order transaction information. Server application 110 and client applications 108a-n can use and present real-time data and historical data from historical database 112. The database 112 may store data in any form suitable for the particular implementation, such as, but not limited to, a relational database and flat files. As such, the database 112 may or may not be accessed via a structured query language (SQL), for example. In addition, financial data server 106 can include cache memory (not shown) for caching selected data, which may be used again later. The server 106 may at times remove selected data from the cache, based on caching rules. In some cases, a trading gateway may facilitate order placement between a trading application and the financial exchange. The trading gateway may be part of the financial data server or may be a separate system component.

In some embodiments, clients 102a-n can subscribe to selected financial instruments, and financial information, or services. Clients 102a-n, financial data server 110, and exchange server(s) 104 communicate via one or more networks. The networks may be wireless, wired, or a combination of wired and wireless. Network components (not shown) and/or components at the clients 102a-n, financial data server 110, and exchange server 104, such as firewalls and network address translators (NATs), may provide for data and system security.

Data communicated between the clients 102a-n and the financial data server 106, and between the financial data server 106 and the exchange server(s) 104 may be “pushed” or “pulled”, or any combination thereof, depending on the situation. For example, akin to pulling, the client 102a may request historical data from the financial data server 106, which will prompt the server side application 110 to retrieve the requested data from the database 112 and send the data to the client 102a. On the other hand, real-time data from the exchange server(s) 104 is typically pushed to one or more of the clients 102a-n by the server side application 110.

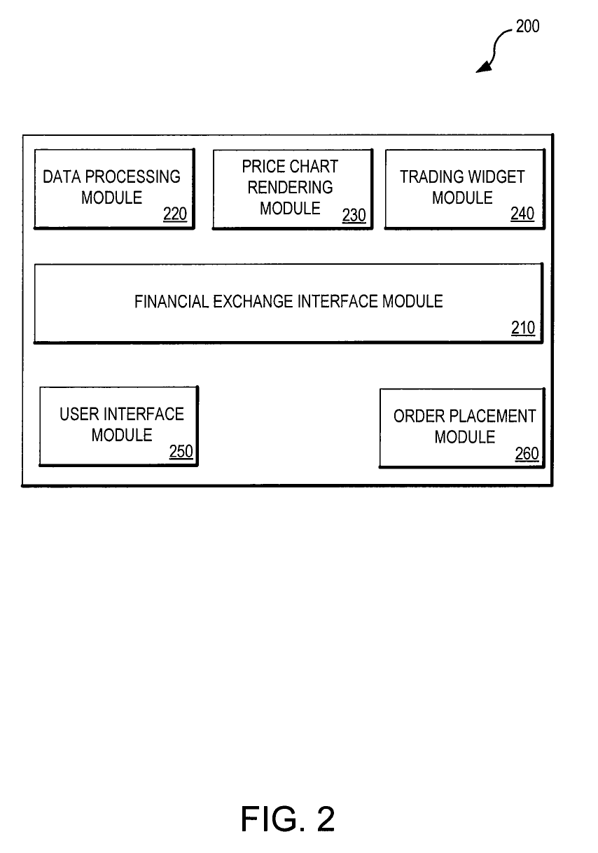

FIG. 2 is a block diagram of various components in an exemplary trading application 200 that uses a trading widget in accordance with various embodiments of the present invention. According to the embodiment shown in FIG. 2, trading application 200 includes a financial exchange interface module 210, a data processing module 220, price chart rendering module 230, a trading widget module 240, a user interface module 250, and an order placement module 260. Other embodiments of the present invention may include some, all, or none of these modules along with other modules or application components. Still yet, various embodiments may incorporate two or more of these modules into a single module.

Financial exchange interface module 210, according to one embodiment, provides an interface between the trading application and financial data server 106, financial exchange server(s) 104, and/or a trading gateway. Financial exchange interface module 210 translates any requests from the trading application into a format required by the destination component. Similarly, module 210 is able to translate and/or direct incoming requests and/or data to the appropriate module within the trading application.

Once data is received through financial interface module 210, data processing module 220 processes the data. In some embodiments, a trader using trading application 200 may select one or more preferences about the data being presented. For example, a trader may prefer to see price data averaged over a certain time interval (e.g., five minutes or hourly) for the day. In some cases a trader may want to see trends in the depth of market. As another example, a trader may desire to monitor movement or trends various financial groups or sectors. In all the cases, and others, data processing module 220 processes the data received from the financial exchange based on system preferences or rules. Module 220 then communicates the results to other modules, such as price chart rendering module 230 and/or trading widget module 240.

Price chart rendering module 230 takes data about a financial instrument received from data processing module 220 and presents the data in a price chart on a display. The type of price chart may depend on user preferences, the type of display, and/or user interactions with the price chart. In some embodiments, price chart rendering module 230 renders information about orders that a trader has placed or is about to place with the financial exchange. For example, an anchoring line may be rendered on the price chart allowing the user to grab the horizontal line and grab it to a new position on the chart. In one embodiment, this action will update the price at which the order will be placed.

The user interaction with the price chart is facilitated by user interface module 250. Various embodiments of user interface module 250 allow for user interaction with the trading application using a computer mouse as an input device. There are also numerous different types of computer mice: two button, three button, having a mouse wheel or roller ball, etc. According to various embodiments, user interface module 250 is able to determine the type of mouse being used and translate actions appropriately. For example, movement of the mouse wheel may adjust the quantity of a financial instrument to be traded or price of a limit or stop order. Other embodiments, however, provide for other input devices such as, but not limited to, a track ball, a keyboard, audio input (e.g., with speech recognition), and/or a touch screen input (e.g., with a stylus). The invention is not limited to any particular type of input device, or any particular type of mouse.

According to various embodiments, trading widget module 240 is responsible for rendering the trading widget on the display device, determining the mode of operation of the trading widget, and monitoring for interactions, such as order placement, trading widget repositioning, and the like, from the trader using trading application 200. In some embodiments, the trading widget displayed on a price chart interacts directly with the price chart. The interactions between the price chart and the trading widget will are described in more detail below. As one example, however, an anchoring line may be rendered on the price chart which will move when the desired price is set. Similarly, movement of the anchoring line will result in the trading price on the trading widget being updated. In one embodiment, trading widget module 240 uses order placement module 260 to submit trading orders to the market.

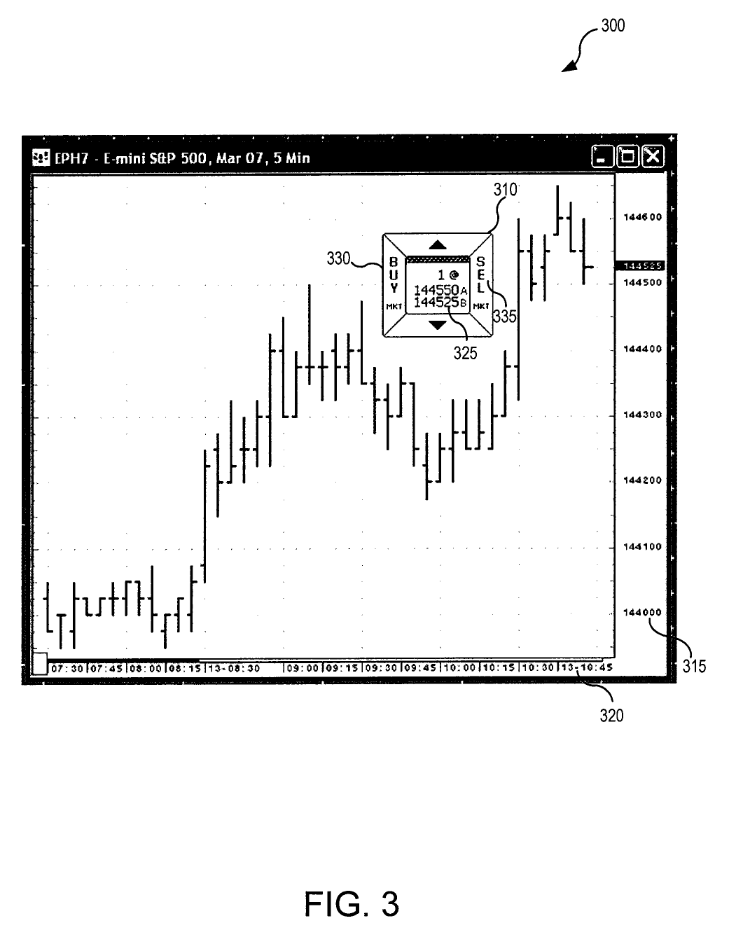

FIG. 3 illustrates an exemplary price chart 300 including a small trading widget 310 for electronic trading of financial instruments. As shown in FIG. 3, price chart 300 is a display where the vertical axis 315 represents price of a financial instrument and the horizontal axis 320 represents time.

According to various embodiments, the price chart 300 and trading widget 310 may be included in trading applications 108a-n in order to facilitate the placement of financial orders with the exchange. According to one embodiment of the present invention, trading widget 310 floats translucently over the surface of price chart 300. In another embodiment, trading widget 310 stays opaque. The trading widget enables a trader to specify parameters of an order (e.g., buy, sell, quantity, price, limits, etc.), and enter the order into an electronic exchange. The trading widget can be moved by the trader, and positioned on the chart where the trading widget is most convenient for trade execution and least intrusive on the display of price or other market information.

According to one embodiment, trading widget 300 may take on a plurality of states or modes. For example, the trading widget may have an inactive mode and one or more active modes. From the inactive mode, the trading widget may be activated when the input device pointer (e.g., mouse pointer) is moved over (e.g., hovers over) the trading widget. In the inactive mode, regions of the trading widget may be, e.g., marked, deemphasized, muted, and/or changed to a translucent state, while in the active mode, regions of the trading widget may be, e.g., highlighted using color, a bold font, or some other marking to indicate which component of the trading widget might be used to initiate an action. For example, in some modes, various trade buttons will be presented. According to one embodiment, a highlighted trade button is one that is enabled for quick order placement.

In accordance with various embodiments, the trading widget includes central region 325 that displays an order quantity and an order price or order prices. According to one embodiment, the default action in response to the trader moving the mouse wheel may be adjusting the order price. If the trader clicks on the display of the quantity the numerals of the quantity may be displayed using a bold font and the mode of the trading widget may change so that the response to the trader moving the mouse wheel may be adjusting the order quantity. If the trader clicks on the bolded quantity, the scroll action response may be restored to the default state. In an alternative implementation, if the trader clicks on the display of the quantity, a quantity text entry field is activated and the trader can modify the quantity by typing a new quantity using the keyboard or by moving the mouse wheel.

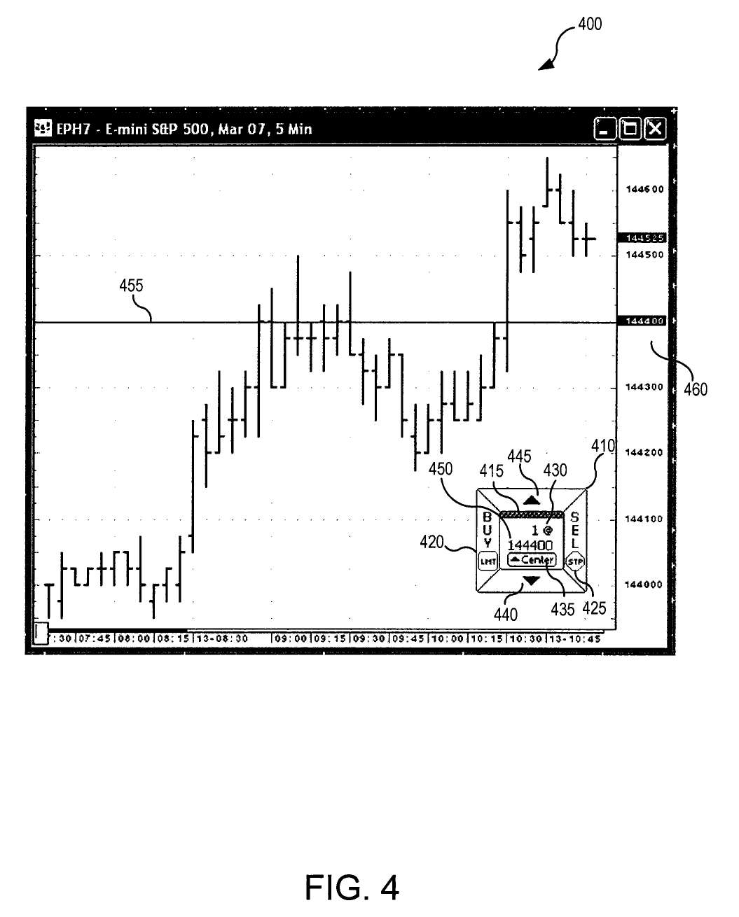

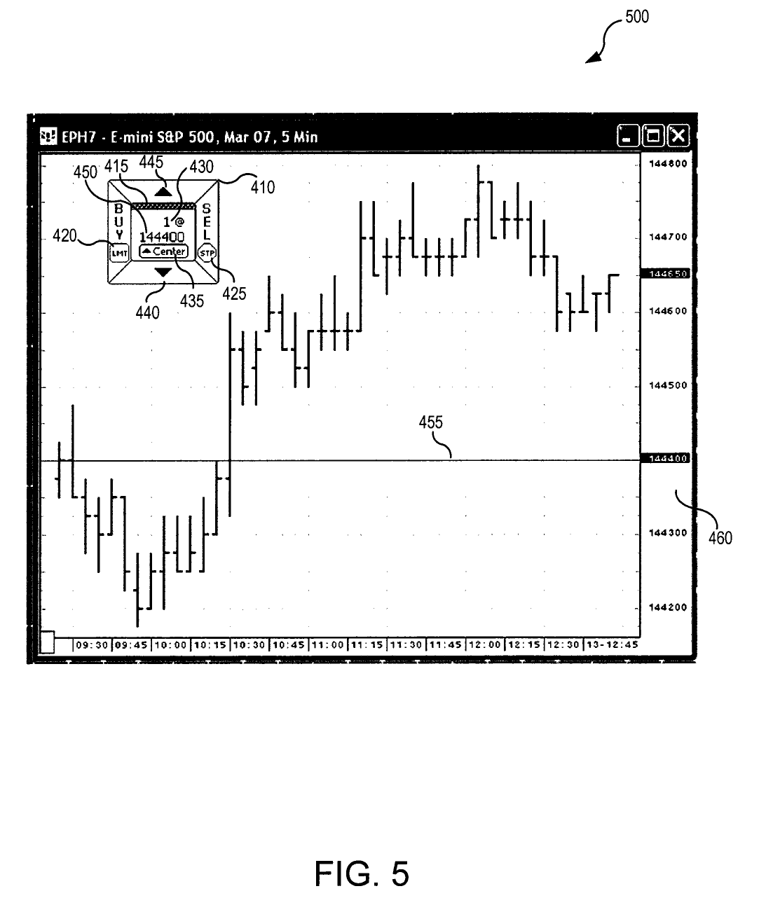

FIG. 4 illustrates another view of an exemplary price chart 400 with a trading widget 410 in accordance with an embodiment of the present invention. Some embodiments of the trading widget contain a handle 415 for grabbing and moving the trading widget. Using the handle 415, a trader may move the trading widget 410 to a more preferential location on the price chart 400. FIG. 5 illustrates the trading widget after it has been repositioned by the trader. According to various embodiments, price chart 400 is being continually refreshed to include new price information as provided by the exchange. This feature is illustrated between price chart 400 and price chart 500 in that the financial instrument data being displayed in price chart 500 is different than the data presented in price chart 400.

In addition to a handle 415 for grabbing and moving the trading widget 410, the trading widget also includes buttons for order commands relating to the trading of financial instruments in accordance with various embodiments. For example, the trading widget illustrated in FIG. 3 includes buttons 330 and 335 for buying and selling the financial instrument at the current market price.

The trading widget illustrated in FIGS. 4-5 includes buttons 420 and 425 for placing limit and stop orders. To place a limit or stop, or stop/limit order, the trader must first establish an order price. According to one embodiment, the default price value will be the current market price. A trader may then adjust the price as desired. In one embodiment, a price adjustment can be accomplished by clicking on the down arrow button 440 to establish a price below the current market or the up arrow button 445 to establish a price above the current market.

Alternatively, the trader may establish an order price using a horizontal cursor. A horizontal cursor is activated by a mouse click with the mouse pointer positioned in the price scale 460. The trader may then establish an order price by positioning the horizontal line by moving the mouse and then anchoring the line with a mouse click.

After a price has been established, the chosen price 450 is displayed in the trading widget and an anchored horizontal line 455 is displayed on the chart that reflects the chosen price. In addition, a centering button 435 appears. The centering button 435 includes an arrow that points upward if the chosen price is below the current market or downward if the chosen price is above the market. In accordance with various embodiments, if the trader presses the centering button 435 the trading widget is restored to the market order state illustrated in FIG. 3 and the associated anchored horizontal line is removed from the chart.

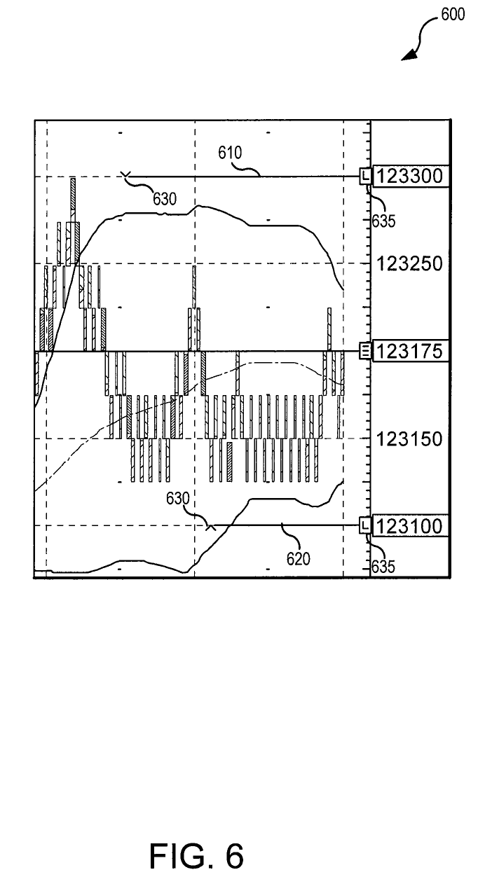

In one embodiment, when a trader places a limit, stop, or stop/limit order by moving the mouse pointer over the desired order button and clicking with the left mouse button a horizontal line that reflects the order price is drawn on the price chart after the order has been acknowledged by the exchange. FIG. 6 illustrates a portion of an exemplary price chart 600 with horizontal lines 610 and 620 drawn to indicate limit orders. In addition to indicating the order price, the starting points 630 of the horizontal lines 610 and 620 indicate the time that the order was placed or entered into the market and the ending points are the current time.

In some embodiments, the horizontal line which represents an order active in the market may have an attached “handle” or label displayed next to the price scale region of the chart indicating what type of order the line represents. For example, the letter “L” 635 indicates that both these lines represent limit orders. Alternatively, the letter “S” might represent a stop order. Other symbols, letters, numerals, and/or combinations thereof may be used in various embodiments as the label displayed to indicate the type of order the line represents.

According to one embodiment, the trader may grab the handle for a horizontal order line and drag it up or down to modify the order price. An order to modify the price may be submitted into the market when the line is dropped at a price other than the original price of the order.

According to one embodiment, the trader may right click on the handle of the horizontal line that represents stop order to display a pop-up menu with an item “Set Limit Price” or similar text in the menu list. If the “Set Limit Price” item is selected from the menu list, a second horizontal limit price line may be displayed a small distance above or below the line that represents the stop price of the order. By grabbing the handle for this new line, the trader may drag it to a desired location reflecting the desired limit price for a stop/limit order. An order to modify the order type from a stop to a stop/limit order and set the limit price may be submitted into the market when the line is dropped at the desired price.

According to an alternative embodiment, if the order that was placed into the market is a stop/limit order and thus is represented by two lines on the price chart when the stop price and the limit price differ, the handle labeled “S” attached to the line that represents the stop price and the handle labeled “L” that represents the limit price may be joined by a vertical line to indicate that the two lines are related.

According to one embodiment, the line and its handle and price label may be colored to reflect whether it is a buy or a sell order. For example, a buy order line may be colored blue while a sell order line may be colored orange.

According to one embodiment, the trader may grab the horizontal order line and drag it sideways off the price chart. When the mouse cursor has been moved off the chart, the horizontal order line and its handle and its price label may be removed from the price chart and the mouse cursor may be changed to reflect a pending cancel order. If a drop then occurs while the mouse cursor has been moved off the price chart, an order to cancel the stop or limit order is submitted into the market.

According to an alternative embodiment, the trader may right click on the handle of the horizontal line that represents an order to display a pop-up menu with an item “Cancel Order” or similar text in the menu list. If the “Cancel Order” item is selected from the menu list, an order to cancel the resting stop or limit order is submitted into the market.

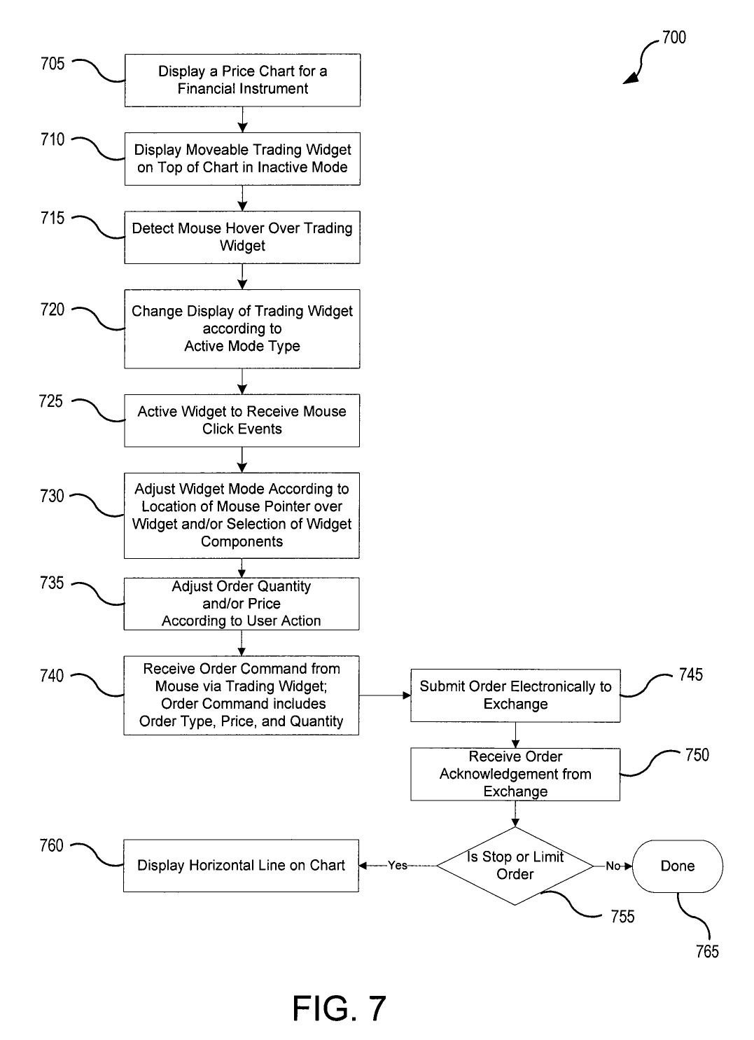

FIG. 7 is a flowchart illustrating an exemplary algorithm 700 for placing an order in accordance with one embodiment of the present invention. Accordingly, various embodiments may include all, part, or none of these operations. In other embodiments, additional operations may also be included with all or part of the operations described in FIG. 7.

In one embodiment, display operation 705 displays a price chart for a financial instrument. A price chart can be a graphical display where a first axis represents price and a second axis represents time. Examples of financial instruments include, but are not limited to, stocks, bonds, mutual funds, Exchange-Traded Funds (EFTs), stock futures, commodity futures, stock options, commodity options and the like.

Widget display operation 710 displays a moveable trading widget on top of the price chart. In one embodiment, the trading widget is initially displayed in a translucent state. According to various embodiments, the translucent level at which the trading widget is displayed may be customized by the user. In one embodiment, widget display operation 710 displays the trading widget in an inactive mode. The inactive mode may be indicated by the translucent appearance of the trading widget.

According to one embodiment, the trading widget mode changes from inactive to active when detection operation 715 detects a mouse hovering over the trading widget. The length of hovering needed for detection operation 715 to detect the mouse is hovering can be set from instantly to several seconds as a preference by a user in many embodiments. In one embodiment, the default length of hovering needed is less than one second.

Once the mouse hovering has been detected, change display operation 720 changes the display of the trading widget according to an active mode type. In various embodiments, the trading widget looses part or all of the translucent property and appears more solid or opaque. In one embodiment, a handle for movement also appears to facilitate the user in repositioning the trading widget as desired.

Activate operation 725, according to one embodiment, activates the trading widget to receive mouse click events from the user. For example, the user of a mouse may use the scroll wheel to adjust the quantity of the financial instrument that will be traded in the order. In one embodiment, a scrolling of the mouse wheel towards the user will raise the quantity while a scrolling of the mouse wheel away from the user will lower the quantity. Still yet, other embodiments allow for inputs to be received from the buttons on the mouse or even from mouse gestures that can be customized by the user. For example, in one embodiment, a default set of gestures may include depressing a mouse button and moving the cursor towards the top of the screen resulting in raising the quantity, depressing a mouse button and moving the cursor towards the bottom of the screen resulting in lowering the quantity, depressing a mouse button and moving the cursor from left to right may transition the trading widget between various different modes of operation or activate/deactivate different features.

According to various embodiments, adjustment operation 730 adjusts the trading widget's mode according to the location of the mouse pointer over the trading widget and/or selection of trading widget components. For example, if the mouse moves outside of the boundaries of the trading widget, the trading widget transitions to inactive mode. If the mouse is within the boundaries of the trading widget the functionality of the trading widget becomes active. An indication that the trading widget is active may be represented by a color change in the background of the trading widget, additional fields or buttons appearing, a visual indication (e.g., the text “trading widget active”) on the price chart, and/or the like.

Adjustment operation 735 adjusts order quantity and/or price according to user action, either by moving the mouse wheel or by entering a numeric value from the keyboard. The trading widget may receive an order command from the user via receive operation 740. According to one embodiment, the order command includes the order type, order price(s), and order quantity. Examples of order types include, but are not limited to, exchange supported orders such as market buys, market sells, stop orders, limit orders, stop/limit orders as well as other “synthetic” order types such as trailing stops that may be supported by a financial trading gateway or by the order placement module 260 described in FIG. 2.

Submission operation 745 then submits the order electronically to the exchange. When receiving operation 750 receives an order acknowledgment from the exchange, then Determination operation 755 determines if the order is a stop, limit, or stop/limit order. If the determination operation 755 determines that the order is a stop, limit, or stop/limit order, display operation 760 will display a horizontal line on the price chart indicating the price where the limit or stop order will be triggered. If determination operation 755 determines the order is not a stop order and not a limit order, then the order placement algorithm is complete with done operation 765.

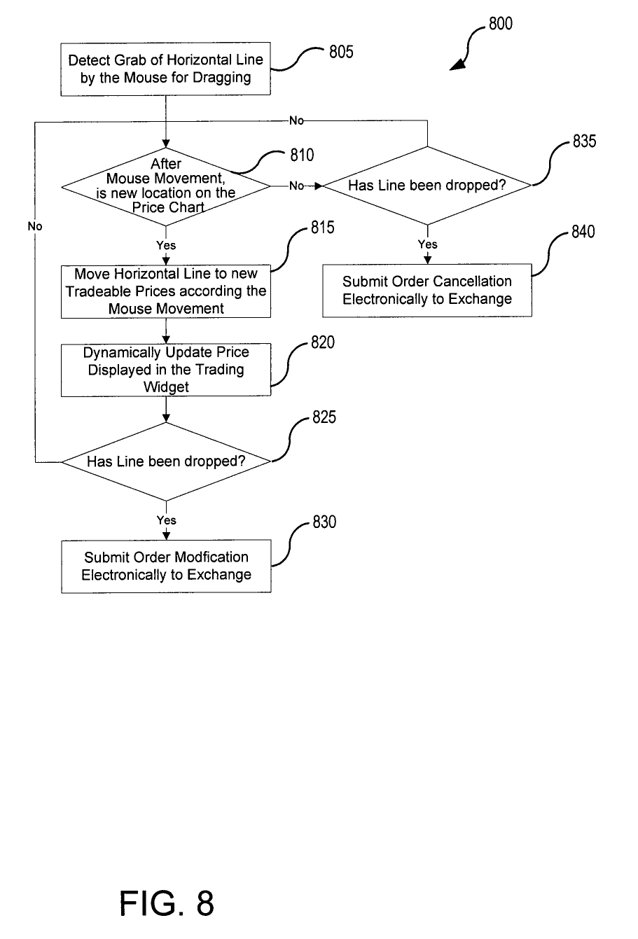

FIG. 8 is a flowchart illustrating an exemplary algorithm 800 for canceling an order in accordance with an embodiment of the present invention. In some embodiments, when a stop or limit order is placed, a horizontal line is displayed on the price chart. According to one embodiment, this line may be moved or deleted by the user and a request is automatically submitted to the electronic exchange modifying or cancelling the order.

Detection operation 805 detects the horizontal line has been grabbed by the mouse and is able to be moved. Determination operation 810 determines if after any mouse movement, the horizontal line is in a new location on the price chart. If the line is in a new location on the price chart, move operation 815 moves the horizontal line to new tradable prices according to the mouse movement. Updating operation 820, dynamically updates the price displayed in the trading widget. Drop determination operation 825 then determines if the line has been dropped. If the line has been released from the grabbing operation, then the order is submitted electronically to the exchange by submission operation 830. If the line has not been released, then the algorithm returns to determination operation 810.

If determination operation 810 determines that the new location of the horizontal line is not on the price chart, then the algorithm branches to drop determination operation 835. Drop determination operation 835 determines whether the horizontal line has been released. If the line has been released, then an order cancellation is electronically submitted to the exchange by submission operation 840. If drop determination operation 835 determines that the line has not been dropped, then the algorithm branches to determination operation 810.

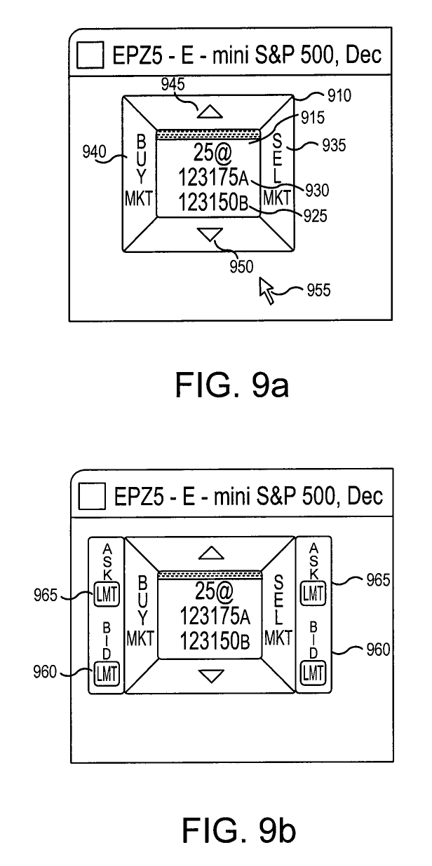

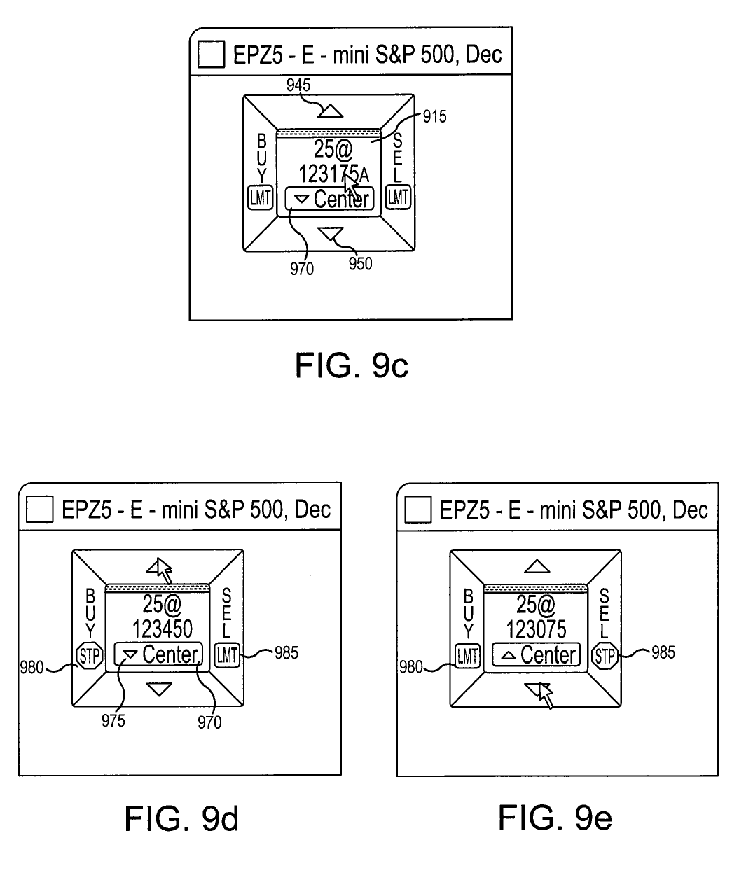

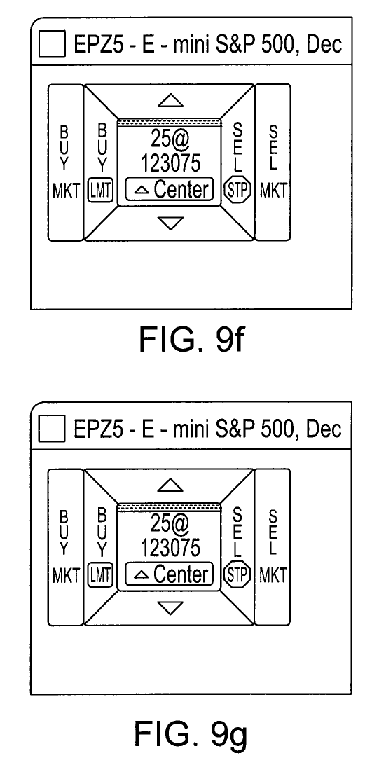

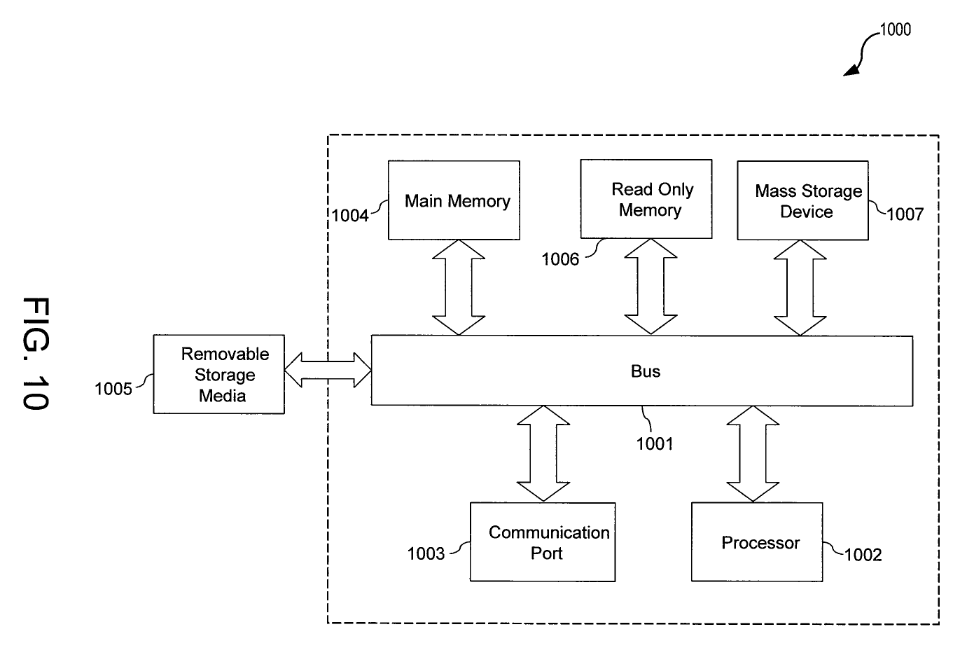

FIGS. 9a-9g show various embodiments of a trading widget. In the embodiment shown in FIG. 9a, the trading widget 910 can enter an order mode called “market mode”. In market mode, the trading widget includes a central region 915 that displays an order quantity 920 as well as the best bid price 925 and the best ask price 930. To the left and right of the central region 915 are two order action buttons 935 and 940 that are used to execute market orders. According to one embodiment, the “BUY MKT” or buy at the market button 940 is placed to the right of the central region 915 and the “SEL MKT” or sell at the market button 935 is placed to the right.

In accordance with various embodiments, above and below the central region 915 are two buttons: an “up” button 945 with which the trader may adjust the order price upwards, and a “down” button 950 with which the trader may adjust the order price downwards and subsequently change the order mode.

According to one embodiment, while in the market mode, when the mouse pointer 955 is moved over either the “BUY MKT” or the “SEL MKT” button (buttons 940 or 935), two additional buttons 960 and 965 as shown in FIG. 9b that allow the placement of a limit order may appear to the right or left, respectively. In this embodiment, the limits associated with the buy and sell limit order buttons are typically the best bid and the best ask prices, respectively.

According to an alternative embodiment, clicking on the best bid price or the best ask or offer price may freeze the price and change the order mode to “limit mode”. FIG. 9c shows one embodiment of the trading widget in the limit mode with order action buttons displaying “BUY LMT” for buy using a limit order at the designated price or “SEL LMT” for sell using a limit order at the designated price. In this embodiment, as long as the frozen price remains either the best bid price or the best ask or offer price, it may be identified as such by a trailing “A” or “B”.

According to one embodiment, each click on the “up” button 945 may move the order price up one tick and each click on the “down” button 950 may move the order price down one tick. Whenever the order price has been set by the trader, a “Center” button 970 may be placed in the central region 915 to provide the function of a quick return to the current market price. This embodiment is illustrated in FIG. 9d The “Center” button 970 may also display an up or down arrow 975 to indicate whether the chosen price is below or above the current market price and to indicate the direction of the centering action.

According to one embodiment, whenever the chosen order price is neither the best bid price nor the best ask or offer price, the trading widget 910 may be said to be in the “stop or limit” mode and the order action buttons shall reflect the position of the price relative to the current market price. For example, if the price is above the current market price, a “BUY STP” button 980 used to place a stop order may be displayed to the left of the central region and a “SEL LMT” button 985 used to place a sell limit order may be placed to the right of the central region. Similarly, if the price is below the current market price, a “BUY LMT” button 990 used to place a limit order may be displayed to the left of the central region and a “SEL STP” button 995 used to place a sell stop order may be placed to the right of the central region as shown in FIG. 9e.

In accordance with an alternative embodiment, using an graphical user interface that permits the choice of order type, the trader may choose to use stop/limit orders rather than stop orders. In such an embodiment, the “STP” icon may be replaced with an “STL” icon to indicate that a stop/limit order will be submitted to the electronic exchange.

In accordance with one embodiment of the present invention, a spanning horizontal line may be displayed on the price chart to mark the price of the pending limit order that is displayed in the trading widget 910. According to an alternative embodiment, the trader may place a spanning horizontal line on the chart by clicking in the chart's price scale region and thereby set the order price in the trading widget. According to one embodiment, the horizontal line may have an attached price label displayed in the price scale region of the chart as well as a handle with which the trader may drag the line up or down to adjust the pending limit order price. As the trader drags the horizontal line, the price displayed in the trading widget changes, according to the tradable prices intersected by the line.

According to one embodiment, when the mouse is moved over the “BUY LMT”, the “BUY STP”, the “SEL LMT”, or the “SEL STP” button, an additional button that allows the placement of a market order may appear to the right or left respectively as illustrated in FIGS. 9f and 9g.

In accordance with some embodiments, display or suppression of any of the described graphical user interface screens is configurable by the end user and/or responsive to end user request.

Embodiments of the present invention may be provided at least in part as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described herein with reference to specific graphical trading widgets, charts, and specific user interface screens for trading financial instruments, the techniques described are equally applicable to various other types of user interfaces and trading applications.

Exemplary Computer System Overview

Embodiments of the present invention include various steps, a variety of which may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 10 is an example of a computer system 1000 with which embodiments of the present invention may be utilized. According to the present example, the computer system includes a bus 1001, at least one processor 1002, at least one communication port 1003, a main memory 1004, a removable storage media 1005, a read only memory 1006, and a mass storage 1007.

Processor(s) 1002 can be any known processor, such as, but not limited to, an Intel® Itanium® or Itanium 2® processor(s), or AMD® Opteron® or Athlon MP® processor(s), or Motorola® lines of processors. Communication port(s) 1003 can be any of an RS-232 port for use with a modem based dialup connection, a 10/100 Ethernet port, or a Gigabit port using copper or fiber. Communication port(s) 1003 may be chosen depending on a network such a Local Area Network (LAN), Wide Area Network (WAN), or any network to which the computer system 1000 connects.

Main memory 1004 can be Random Access Memory (RAM), or any other dynamic storage device(s) commonly known in the art. Read only memory 1006 can be any static storage device(s) such as Programmable Read Only Memory (PROM) chips for storing static information such as instructions for processor 1002.

Mass storage 1007 can be used to store information and instructions. For example, hard disks such as the Adaptec® family of SCSI drives, an optical disc, an array of disks such as RAID, such as the Adaptec family of RAID drives, or any other mass storage devices may be used.

Bus 1001 communicatively couples processor(s) 1002 with the other memory, storage and communication blocks. Bus 1001 can be a PCI/PCI-X or SCSI based system bus depending on the storage devices used.

Removable storage media 1005 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for efficiently trading financial products using trading widgets in trading applications. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A method comprising:
receiving price data related to a financial instrument from an electronic exchange;
dynamically presenting the price data as it is received from the electronic exchange in a price chart;
displaying a trading widget on the price chart;
monitoring cursor movements of a trader to determine if the cursor has been positioned over or in proximity to the trading widget; and
changing the trading widget from operating in an inactive mode when the cursor is not positioned over or in proximity to the trading widget to an active mode when the cursor is positioned over or in proximity to the trading widget.

2. The method of claim 1, wherein the trading widget is initialized in the inactive mode when first displayed on the price chart.

3. The method of claim 1, wherein the trading widget is moveable by the trader.

4. The method of claim 1, further comprising:
receiving from the trading widget an order command representing an order to be placed with the electronic exchange; and
submitting the order to the electronic exchange.

5. The method of claim 4, further comprising establishing an order price by using a horizontal cursor activated by a user interface device or using an up button or a down button included in the trading widget, and wherein submitting the order to the electronic exchange includes submitting the established order price.

6. The method of claim 5, wherein after establishing the order price the method further comprises:
displaying the established order price in the trading widget; and
displaying a spanning anchored horizontal line at a first position on the price chart reflecting the established order price.

7. The method of claim 5, further comprising:
monitoring cursor movements of the trader to determine if the trader engages the spanning horizontal line at the first position and drags the line to a second position located within the price chart; and
modifying the order price when the spanning horizontal line is anchored at the second position located within the price chart; and
displaying the newly established order price in a central region of the trading widget.

8. The method of claim 5, further comprising displaying a centering button on the trading widget that when depressed causes the trading widget to transition to a market order mode, wherein the centering button includes an arrow pointing upward if the order price is below the current market price or an arrow pointing downward if the order price is above the current market price

9. The method of claim 1 further comprising:
receiving an input from a user interface device selecting a desired order button on the trading widget, wherein the desired order button is a limit, stop, or stop/limit button; and
submitting the specified order to be executed on the electronic exchange.

10. The method of claim 1, wherein changing the trading widget from operating in the inactive mode to the active mode includes displaying additional order placement buttons.

11. A method comprising:
receiving price data related to a financial instrument from an electronic exchange;
dynamically presenting the price data in a price chart as the data is received from the electronic exchange;
submitting an order to the electronic exchange to trade the financial instrument, wherein the order is a limit order, a stop order, or a stop/limit order at a set of specified order prices;
receiving an order acknowledgement from the electronic exchange indicating the order has been accepted by the electronic exchange; and
displaying a horizontal line at a first location on the price chart representing the accepted order, wherein the first location represents at least one of the specified order prices.

12. The method of claim 11, wherein the horizontal line includes a handle located on a price scale region of the price chart indicating the type of order the line represents.

13. The method of claim 12, wherein the handle includes the letter “S” indicating the accepted order is a stop order or the letter “L” indicating the accepted order is a limit order.

14. The method of claim 11, further comprising:
monitoring cursor movements of the trader to determine if the horizontal line representing the accepted order has been engaged and then dragged and dropped at a new location; and
submitting a modified order to the electronic exchange if the new location is within the price chart and is different from the first location of the horizontal line.

15. The method of claim 11, further comprising:
monitoring cursor movements of the trader to determine if the horizontal line representing the accepted order has been engaged and then dragged and dropped at a new location; and
submitting an order cancellation to the electronic exchange if the new location is outside of the price chart.

16. A computer-implemented method comprising:
displaying a first user interface screen on a terminal, the first user interface screen including a price chart to display information received from an exchange about a financial instrument;
displaying a graphical trading widget on the terminal in an inactive state;
displaying the graphical trading widget on the terminal in an active mode, wherein the graphical trading widget enters the active mode when a cursor is positioned over or in proximity to the graphical trading widget; and
dynamically updating a price field on the graphical trading widget in response to data received from an electronic exchange.

17. The method of claim 16, wherein displaying the graphical trading widget in the inactive state causes the graphical trading widget to be translucent and displaying the graphical trading widget in the active mode causes the trading widget to be opaque.

18. The method of claim 16, wherein displaying the graphical trading widget in the inactive state causes the graphical trading widget to be displayed with a reduced number of order buttons.

19. The method of claim 16, further comprising dynamically updating a volume field on the graphical trading widget in response to commands received from a user.

20. The method of claim 16, further comprising dynamically updating a best ask price field and a best bid price field received from an electronic exchange on the graphical trading widget.

21. The method of claim 16, further comprising displaying a horizontal line on the price chart indicating a limit or stop order that has been placed.

22. A computer-implemented financial trading system comprising:
a financial exchange interface module configured to receive financial instrument data from a financial exchange;
a price chart rendering module communicably coupled to the financial exchange interface module and configured to graphically display the financial instrument data received form the financial exchange on a display device;
a trading widget module configured to graphically present a trading widget on the display device and receive financial orders from the trading widget; and
an order placement module configured to communicate with the trading widget module and submit the received financial orders to the financial exchange.

23. The financial trading system of claim 22, further comprising a data processing module configured to receive financial data from the financial exchange and process the financial data before transmitting the financial data to the price chart rendering module.

24. The financial trading system of claim 22, wherein the financial exchange interface module is communicably coupled to a financial data server configured to receive financial instrument information data from one or more financial exchange servers.

25. The financial trading system of claim 22, wherein the financial exchange interface module is communicably coupled to a historical database storing historical data about a financial instrument.

26. A computer-readable medium containing a set of instructions capable of causing one or more processors to generate a trading widget with a plurality of states, wherein the plurality of states include one or more of:
an inactive mode causing the trading widget to be displayed in a translucent state;
an active mode resulting from the detection of a cursor positioned over or in proximity to the trading widget, wherein the active mode causes the trading widget to be displayed in an opaque state and allows a user to submit orders to an electronic exchange; and
wherein the active mode includes a plurality of operational modes determined by the cursor position, wherein the plurality of operational modes include:
a market mode causing the trading widget to display in a central region one or more of an order quantity, a best bid price, and/or a best ask price of a financial instrument and to the side of the central region two order action buttons usable to execute market orders; and
a stop or limit mode causing the trading widget to display in a central region one or more of an order quantity, a price of the financial instrument, and a center button that when depressed, returns the trading widget to the market mode, and displays to the side of the central region two order action buttons usable to execute stop and limit orders.
